(19) United States
(12) Patent Application Publication
(10) Pub. No.: US 2009/0115659 A1
(43) Pub. Date: May 7, 2009

(54) Receiver device for satellite positioning system

(75) Inventors: Yusuke Watanabe, Anjo-city (JP); Masayuki Nakabuchi, Hekinan-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/285,376

(22) Filed: Oct. 2, 2008

(30) Foreign Application Priority Data
Oct. 5, 2007 (JP) 2007-262228

(51) Int. Cl. G01S 1/00

(52) U.S. Cl. 342/357.12

(57) ABSTRACT

A receiver device has a plurality of signal reception processing circuits, which processes GPS positioning signals of different carrier wave frequencies received by an antenna. In the receiver device, the positioning signals are converted into intermediate frequency signals in a first stage, which includes phase shifters, mixers and complex filters. The receiver device further has dividers of frequency-dividing ratios, which are set variably in accordance with the carrier wave frequencies in the respective signal reception processing circuits. By changing the frequency-dividing ratios, the receiver device can be adapted to receive other positioning signals.

### CROSS REFERENCE TO RELATED APPLICATION

This application is based on and incorporates herein by reference whole contents of Japanese Patent Application No. 2007-262228 filed on Oct. 5, 2007.

### FIELD OF THE INVENTION

The present invention relates to a receiver device for a satellite positioning system, in which positioning signals transmitted from positioning system satellites are received by a plurality of signal reception processing circuits.

### BACKGROUND OF THE INVENTION

As satellite positioning systems for determining the present position or speed of a mobile body such as a vehicle, a global positioning system (GPS) is commercialized and in practical use in navigating airplanes, ships and vehicles. In addition to the GPS, a global orbiting navigation satellite system (GLONASS) has been developed and is operated in Russia, and Galileo system has been developed and is operated jointly by international cooperation headed by European Union (EU).

The positioning principle and positioning calculation are generally the same between GPS and Galileo, but the pseudo noises (PN codes) and the carrier wave frequencies, which are used in spread spectrum modulation of positioning signals transmitted from positioning satellites are set differently from each other.

IP 7-128423A proposes a common receiver device adapted for a plurality of positioning systems and configured to perform signal reception of positioning signals by a plurality of signal reception processing circuits. For example, this common receiver device is configured as a GPS/GLONASS receiver device, which is capable of receiving both positioning signals of GPS satellites and positioning signals of GLONASS satellites.

This common receiver device sets, in a first-stage image removing mixer, a frequency of a local oscillation signal to a frequency, which is intermediate between carrier wave frequencies of the positioning signals of the GPS satellite and the GLONASS satellite. The common receiver device then separates the positioning signals of the GPS satellite and the GLONASS satellite, and converts in frequency from a radio frequency (RF) signal to an intermediate frequency (IF) signal. The common receiver device thus receives the positioning signals of different carrier wave frequencies by two signal reception processing circuits.

In this common receiver device, the positioning signals of the GPS satellite and the GLONASS satellite, which are different in carrier wave frequencies, are separated by the image removing mixer provided in the first stage, and the IF signals of both positioning signals converted in frequency from the carrier wave frequency to the intermediate frequency are further converted in frequency by a mixer provided in a second stage.

That is, the above common receiver device is in a double-superheterodyne circuit configuration. Since the receiver device of the double-superheterodyne circuit configuration performs frequency conversion by two mixers in two stages, noise mixed in the frequency conversion process in the first stage increases in the second frequency conversion process in the second stage multiplicatively. As a result, the receiver device of the double-superheterodyne configuration is susceptible to noise.

If the positioning signals of different carrier wave frequencies are converted in frequency in the first stage by using the intermediate frequency between the two different carrier wave frequencies as the frequency of the local oscillation signal, the intermediate frequency in the first stage becomes high as the difference between the different carrier wave frequencies of the positioning signals.

For example, if the two positioning signals are converted to IF signals in the first stage by setting the frequency of the local oscillation signal to the intermediate frequency between the carrier wave frequency of 1575.42 MHz of L1 signal of GPS and the carrier wave frequency of 1176.45 MHz of L5 signal, the frequency of the IF signal becomes 200 MHz.

It is difficult to configure a band-pass filter (BPF), which limits the pass-band to about 10 MHz for example, for the high frequency signal of 200 MHz, because the ratio of the pass-band relative to the input frequency is small. In the case of integrated circuits, circuit variations are not small. Therefore, in limiting the band-pass of high frequency signals of over 100 MHz, the BPF need be configured to have a wide pass-band in consideration of the circuit variations.

If the pass-band is widened, more noise will be mixed. It is therefore not possible to configure the BPF in the first stage in the integrated circuit in converting the positioning signals, which have large frequency difference, into the intermediate frequency signals.

In the above common receiver device, three mixers are provided. Further, since the positioning signals are converted in frequency in two stages, two BPFs are provided in each signal reception processing circuit. As a result, the common receiver device will become large in size and consume more electric power.

### SUMMARY OF THE INVENTION

It is therefore an object of the present invention to provide a receiver device for a satellite positioning system, which is capable of receiving positioning signals of a plurality of carrier wave frequencies and highly resistive to noise.

According to one aspect of the present invention, a receiver device for a satellite positioning system includes at least first and second signal reception processing circuits, which receive and process positioning signals transmitted from satellites. The receiver device comprises an oscillation signal generator, first and second frequency dividers, first and second mixers. The oscillation signal generator generates a reference oscillation signal of a predetermined frequency. The first and the second frequency dividers are provided in the first and the second signal reception processing circuits, and produce first and second local oscillation signals by dividing the reference oscillation signal by first and second dividing ratios corresponding to carrier wave frequencies of the positioning signals, respectively. The first and second mixers are provided in the first and the second signal reception processing circuits, and converts the positioning signals to first and second intermediate frequency signals in a single stage by mixing the positioning signals and the first and the second local oscillation signals, respectively.

### BRIEF DESCRIPTION OF THE DRAWINGS

The above and other objects, features and advantages of the present invention will become more apparent from the following detailed description made with reference to the accompanying drawings. In the drawings:

FIG. 1 is a circuit diagram showing a receiver device according to the first embodiment of the present invention;

FIG. 2 is a circuit diagram showing a receiver device according to the second embodiment of the present invention;

FIG. 3 is a circuit diagram showing a receiver device according to the third embodiment of the present invention; and

FIG. 4 is a circuit diagram showing a receiver circuit according to the fourth embodiment of the present invention.

### DETAILED DESCRIPTION OF THE EMBODIMENT

The present invention will be described in more detail with reference to various embodiments. These embodiments are directed to receive and process the following three-frequency, five types of positioning signals, which are used in each satellite positioning system of GPS and Galileo.

(1) GPS-L1 and Galileo-E1 (both 1575.42 MHz, and referred to as L1 collectively)
(2) GPS-L2 (1227.6 MHz, and referred to as L2)
(3) GPS-L5 and Galileo-E5a (both 1176.45 MHz, and referred to as L5 collectively)

The carrier wave frequencies of all the positioning signals (1) to (3) are multiples of fo=1.023 MHz. The carrier wave frequencies of the positioning signals of L1, L2 and L5 are thus represented as 1540fo, 1200fo and 1150fo, respectively.

In GPS and Galileo, the positioning signals are transmitted after being subjected to the spread spectrum modulation by using predetermined PN codes.

### First Embodiment

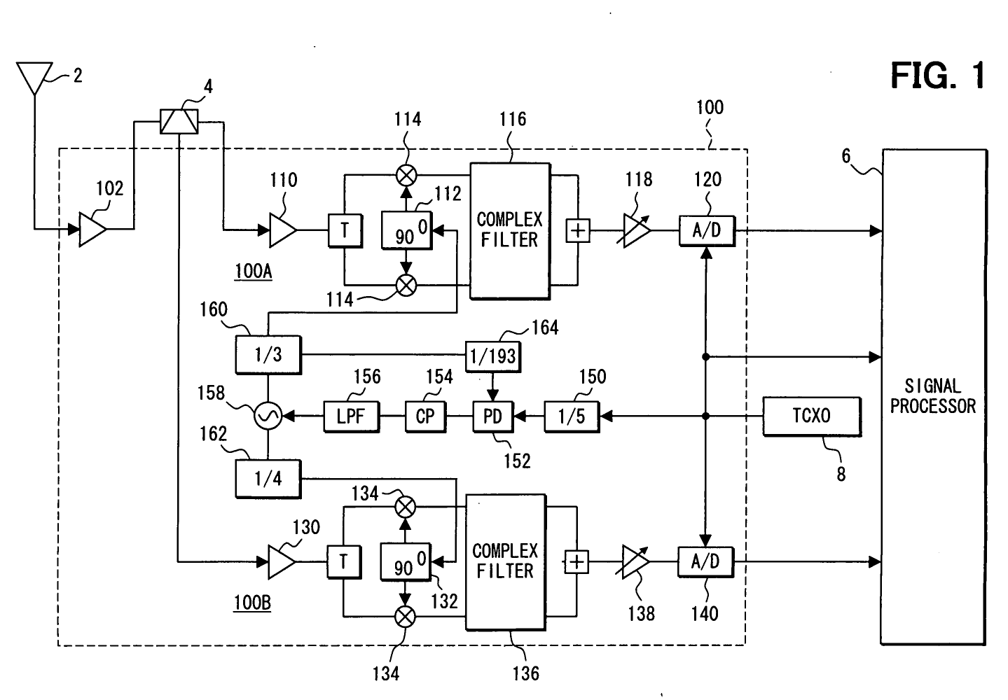

Referring to FIG. 1, a receiver device 100 is provided for converting, in frequency, each positioning signal received from a positioning satellite from a carrier wave radio frequency (RF) to an intermediate frequency (IF).

A signal processor 6 is provided for demodulating the received positioning signal by acquiring the carrier wave of the positioning satellite, which has transmitted the positioning signal, and the PN code used in the spread spectrum modulation by the positioning satellite. The signal processor 6 calculates an estimated distance to and the position of the positioning satellite by using the demodulated positioning signal and performs various corrections such as delay in electric field layer, thereby determining present position, speed, direction and the like of a mobile body such as a vehicle including an antenna 2, the receiver device 100 and the processor 6.

The positioning system of the receiver device 100 may be defined by a memory (ROM) in the signal processor 6.

The receiver device 100 may be configured in a single integrated circuit chip or a plurality of chips. The signal processor 6 may also be integrated into the receiver device 100.

The receiver device 100 converts the positioning signals of different carrier wave frequencies received by the antenna 2 into intermediate frequency signals by two signal reception processing circuits 100A and 100B, and outputs the converted signals as digital signals. The signal processor 6 demodulates the digitalized positioning signals output from the receiver device 100 and performs positioning calculation.

The receiver device 100 includes a low-noise amplifier (LNA) 102, first and second RF amplifiers 110 and 130, first and second phase shifters 112 and 132, first and second mixers 114 and 134, first and second complex filters 116 and 136, first and second automatic gain control (AGC) amplifiers 118 and 138, first and second analog/digital (A/D) converters 120 and 140, frequency dividers 150 and 164, first and second frequency dividers 160 and 162, phase detectors (PD) 152, a comparator (CP) 154, a low-pass filter (LPF) 156, a voltage-controlled oscillator (VCO) 158 and the like.

The RF amplifier 110, phase shifter 112, mixers 114, complex filter 116, AGC amplifier 118 and A/D converter 120 form one signal reception processing circuit 100A. The RF amplifier 130, the phase shifter 132, mixers 134, complex filter 136, AGC amplifier 138 and A/D converter 140 also form the other signal reception processing circuit (100B).

The phase detector 152, comparator 154, low-pass filter 156 and dividers 150, 164 form a circuit, which determines the phase and the frequency of a reference oscillation signal generated by the oscillator 150 in accordance with the frequency-dividing ratio of the dividers 150 and 164.

The antenna 2 may be a dual band antenna, which has poles either at L1 and L2 or at L1 and L5 to receive either the position signals of L1 and L2 or the position signals of L1 and L5. The antenna 2 may alternatively be a triple band antenna, which has one pole in a frequency band of L1 and the other pole in a frequency band intermediate between the frequency bands of L2 and L5. The antenna 2 may be a triple band antenna, which has poles in frequency bands of positioning signals of L1, L2 and L5. The antenna 2 is thus capable of receiving the positioning signals from the GPS satellites and Galileo satellites.

The RF signal of each positioning signal received by the antenna 2 is amplified by the amplifier 102. The amplifier 102 may be a dual band type, which has two poles in either the frequency bands of L1 and L2 or the frequency bands of L1 and L5 to amplify either signals of L1 and L2 or signals of L1 and L5. It may alternatively be a triple band type, which has one pole in L1 and the other pole in a frequency band intermediate between the frequency bands of L2 and L5. It may also be a wide-band type, which has only one pole and amplifies all the frequency bands of signals of L1, L2 and L5.

The RF signal of each positioning signal amplified by the amplifier 102 is limited in pass-band frequency by the filter 4. The filter 4 may be configured as a surface acoustic wave (SAW) filter or the like. The filter 4 may be a dual band type, which passes only the signals in the frequency bands of either L1 and L2 or L1 and L5. It may alternatively be a triple band type, which passes only the signals in the frequency bands of L1, L2 and L5.

The RF signal of each positioning signal, which has passed the filter 4 is amplified by the RF amplifier 110 or 130, shifted 90 degrees in phase by the phase shifter 112 or 113, and mixed with the local oscillation signal of the frequency corresponding to the carrier wave frequency of the positioning signal by the mixer 114 or 134.

It is assumed here that the signals of L1 and L5 are received and processed in the receiver device 100. The local oscillation signals, which are mixed with the positioning signals of L1 and L5 by mixers 114 and 134, respectively, are produced by dividing a reference oscillation signal (frequency of 4632fo) of the oscillator 158 to one-third (frequency 1544fo) by the divider 160 and to one-fourth (frequency 1158fo) by the divider 162. The frequency of the reference oscillation signal of the oscillator 158 is set to be sufficiently high in comparison with the frequency (40fo) of a reference clock generated by a temperature-compensated crystal oscillator (TCXO) 8.

The positioning signal of L1 is mixed with the local oscillation signal of frequency of 1544fo in the mixer 114 and converted in frequency from the carrier wave frequency of 1540fo to the intermediate frequency of 4fo. The positioning signal of L5 is mixed with the local oscillation signal of frequency of 1158fo in the mixer 134 and converted in frequency from the carrier wave frequency of 1150fo to the intermediate frequency of 8fo.

The positioning signal converted into the intermediate frequency signal by the mixer 114 or 134 is subjected to image removal by the complex filter 116 or 136. The positioning signal is then amplified by the amplifier 118 or 138 to a level required by the A/D converter 120 or 140. After being A/D-converted by the A/D converter 120 or 140, the digital signal corresponding to the positioning signal is supplied to the signal processor 6.

The signal processor 6 generates the same PN code as used in performing the spread spectrum modulation of the positioning signal, and performs spectrum despreading of the positioning signal. The signal processor 6 then calculates the present position, speed, direction of the mobile body by analysing the despread positioning signal.

In the first embodiment, the first and the second frequency-dividing ratios of the first and the second dividers 160 and 162 are set to different ratios in correspondence to the carrier wave frequencies of the positioning signals, and each positioning signal is converted into the intermediate frequency signal by the frequency conversion processing of one stage formed by the phase shifter 112 or 132, mixers 114 or 134 and complex filter 116 or 136. As a result, the noise tolerance can be improved relative to the case in which the frequency conversion processing is performed in two or more stages.

The frequencies of the local oscillation signals are also set differently between the first and the second signal reception processing circuits 100A and 100B in correspondence to the carrier wave frequencies of the positioning signals. As a result, the carrier wave frequencies can be converted by the mixers 114 and 134 into the intermediate frequencies of 4fo and 8fo.

Thus, the complex filters 116 and 136 can be configured into an integrated circuit, the receiver device 100 can be integrated into a single chip or a plurality of chips.

Since the positioning signals of the carrier wave frequencies are converted into the intermediate frequency signals by only one stage of frequency conversion, the receiver device 100 can be configured in a small size and the power consumption can be reduced.

### Second Embodiment

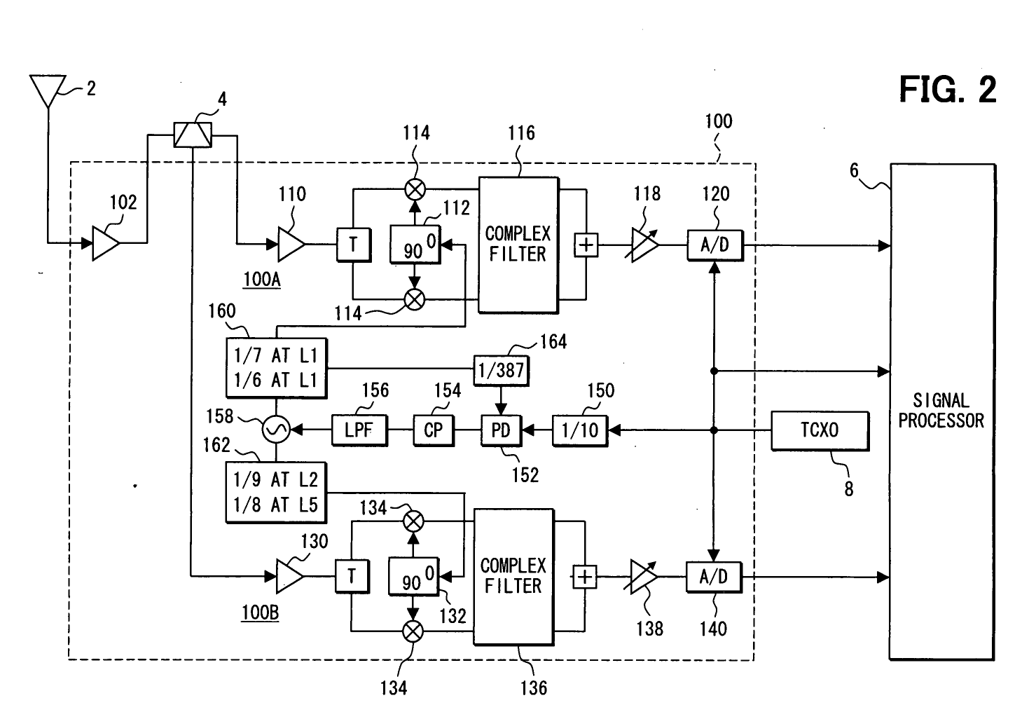

In the second embodiment shown in FIG. 2, the frequency dividing ratios of the dividers 150, 160, 162 and 164 are set to different ratios relative to those in the first embodiment.

The frequency dividing ratios of each of the dividers 160 and 162 are switchable between two ratios to receive the positioning signals of three different carrier wave frequencies of either L1 and L2 or L1 and L5.

When the receiver device 100 receives the positioning signals of L1 and L2, the local oscillation signals, which are mixed with the positioning signals in the mixers 114 and 134, are provided by setting the frequency of the reference oscillation signal of the oscillator 158 to 10836fo and dividing it to one-seventh (1548fo) by the divider 160 and to one-ninth (1204fo) by the divider 162.

The positioning signal of L1 is mixed with the local oscillation signal of the frequency of 1548fo in the mixers 114, so that the frequency is converted from the carrier wave frequency of 1540fo to the intermediate frequency of 8fo.

The positioning signal of L2 is mixed with the local oscillation signal of the frequency of 1204fo in the mixers 134, so that the frequency is converted from the carrier wave frequency of 1200fo to the intermediate frequency of 4fo.

When the receiver device 100 receives the positioning signals of L1 and L5, the local oscillation signals, which are mixed with the positioning signals in the mixers 114 and 134, are provided by setting the frequency of the reference oscillation signal of the oscillator 158 to 9288fo and dividing it to one-sixth (1548fo) by the divider 160 and to one-eighth (1161fo) by the divider 162.

The positioning signal of L1 is mixed with the local oscillation signal of the frequency of 1548fo in the mixers 114, so that the frequency is converted from the carrier wave frequency of 1540fo to the intermediate frequency of 8fo. The positioning signal of L5 is mixed with the local oscillation signal of the frequency of 1161fo in the mixers 134, so that the frequency is converted from the carrier wave frequency of 1150fo to the intermediate frequency of 11fo.

The positioning signals, which have been converted into the intermediate frequency signal by the mixers 114 and 134, are subjected to image removal in the complex filters 116 and 136, respectively. Since the positioning signal of L1 is converted in frequency to 8fo by the mixers 114 in both cases that the positioning signals of L2 and L5 are converted to 4fo and 11fo by the mixers 134, the pass-band and the central frequency of the complex filter 116 may be fixed and need not be changed.

The signal reception processing circuit for L2 and L5, and the intermediate frequencies are 4fo and 11fo. The band widths of L2 and L5 are 2 MHz and 20 MHz, respectively. By setting the band width of the complex filter 136 to be capable of processing the signal of L5 of band width 20 MHz, the frequency characteristic of the filter 136 need not be changed. Even if it needs be changed, the signals of both L1 and L5 can be processed with a small change. By thus setting the band width of the complex filter 136 for L5, the positioning signal of L2 can be passed without being attenuated so much in the signal reception processing for I2.

According to the second embodiment, the positioning signals of three kinds of carrier wave frequencies of L1 and L2 or L1 and L5 can be processed by two signal reception processing circuits 100A and 100B by switching over the frequency dividing ratios of the dividers 160 and 162.

That is, without changing the circuit configuration of the receiver device 100, the positioning signals of different combinations of carrier wave frequencies can be received and processed. That is, the receiver device 100 can receive and process positioning signals of a number of different carrier wave frequencies which is more than the number of its signal reception processing circuits.

### Third Embodiment

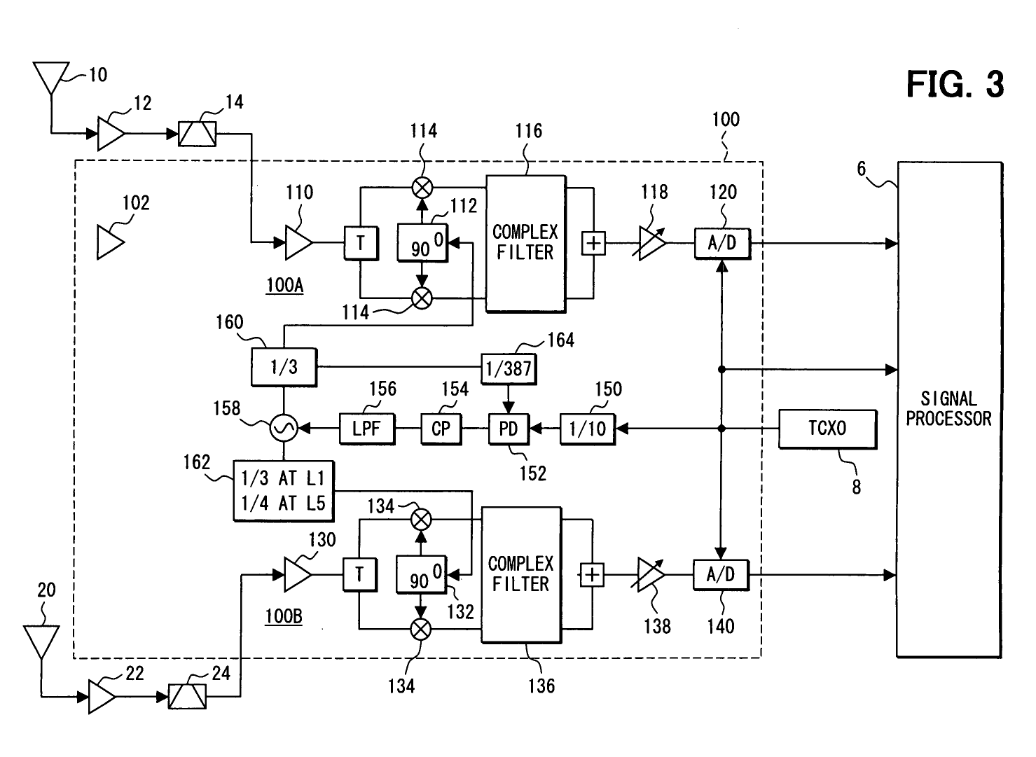

In the third embodiment shown in FIG. 3, the frequency dividing ratios of the dividers 160 and 162 are set to different ratios from those in the second embodiment.

Further, in place of the antenna 2 of the dual band and the filter 4 of the dual band in the second embodiment, first and second antennas 10 and 20 of single band, first and second low noise amplifiers 12 and 22 of single band and first and second band-pass filters 14 and 24 of single band are used. The low-noise amplifier 102 provided in the receiver device 100 is connected nowhere, and not used.

The antennas 10 and 20, the amplifiers 12 and 22 and the filters 14 and 24 have only one pole that corresponds to the frequency band of L1. Both of the signal reception processing circuits 100A and 100B are configured to receive and process the positioning signals of L1 of the same carrier wave frequency. The amplifiers 12 and 22 may be provided in the antennas 10 and 20, respectively, or may be provided separately from the antennas 10 and 20.

The frequency dividing ratio of the divider 160 is fixed to one-third. The frequency dividing ratio of the divider 162 is switchable between one-third and one-fourth, which is for L5. The receiver device 100 is thus configured to receive and process the positioning signals of three carrier wave frequencies, that is, either L1 and L2 or L1 and L5 as in the second embodiment. The receiver device 100 is configured to have two signal reception processing circuits for L1.

When the receiver device 100 receives the same positioning signal of L1 by two signal reception processing circuits 100A and 100B, the positioning signal received by the antennas 10 and 20 are amplified by the amplifiers 12 and 22, and then limited in pass-band by the filters 14 and 24.

The local oscillation signal, which is to be mixed with the positioning signal of L1 in the mixers 114 and 134, are provided by frequency-dividing the reference oscillation signal of frequency 4644fo to one third (1548fo) by the dividers 160 and 162. The reference oscillation signal of frequency of 4644fo generated by the oscillator 158 is set sufficiently higher than the reference clock (frequency of 40fo) generated by the crystal oscillator 8.

The positioning signal of L1 is mixed with the local oscillation signal of frequency of 1548fo in the mixers 114 and 134 and converted in frequency from the carrier wave frequency of 1540fo to the intermediate frequency of 8fo.

In receiving and processing the same positioning signal of L1 in the two signal reception processing circuits, the positioning signal of L1 is processed in the signal reception processing circuit having the wider frequency band for L5. The positioning signal can be detected with high accuracy based on the positioning signal processed by the wide-band processing circuit provided for L5. The positioning errors caused by multiple paths can be reduced.

When the receiver device 100 receives the positioning signals of L1 and L5, the local oscillation signals are provided by dividing the frequency of the reference oscillation signal of frequency of 4644fo of the oscillator 158 to one-third (1548fo) by the divider 160 and to one-fourth (1161fo) by the divider 162.

The positioning signal of L5 is mixed with the local oscillation signal of the frequency of 1161fo in the mixers 134, so that the frequency is converted from the carrier wave frequency of 1150fo to the intermediate frequency of 11fo.

In the signal reception processing circuit for L1 and L5, the intermediate frequencies for L1 and L5 are set to 8fo and 11fo, respectively. The band widths of L1 and L5 are 2 MHz and 20 MHz, respectively. Therefore, by setting the band width of the complex filter 136 to be capable of processing the band width of 20 MHz of L5, both positioning signals of L1 and L5 can be processed without changing the frequency characteristic of the complex filter 136 or by making only a small change to the frequency characteristic.

According to the third embodiment, the two signal reception processing circuits 100A and 100B may be used to process the same positioning signal of L1 in parallel or to process the different positioning signals of L1 and L5.

When the positioning signal of L1 is received by two antennas 10 and 20 and processed by the two signal reception processing circuits 100A and 100B in parallel, there arises a phase difference between received positioning signals of L1 because the antennas 10 and 20 are located at different positions. It is therefore possible to detect posture or attitude of the mobile body such as a vehicle based on such a phase difference.

If the frequency band of the band-pass filter is widened, more noise are likely to enter but the reception characteristic of the received signal becomes sharp. As a result, the accuracy of detection of the signals can be enhanced and the multiple paths can be reduced.

If the frequency band of the band-pass filter is narrowed, less noise are likely to enter but the reception characteristic of the received signal becomes dull. Thus, anti-noise performance is improved.

### Fourth Embodiment

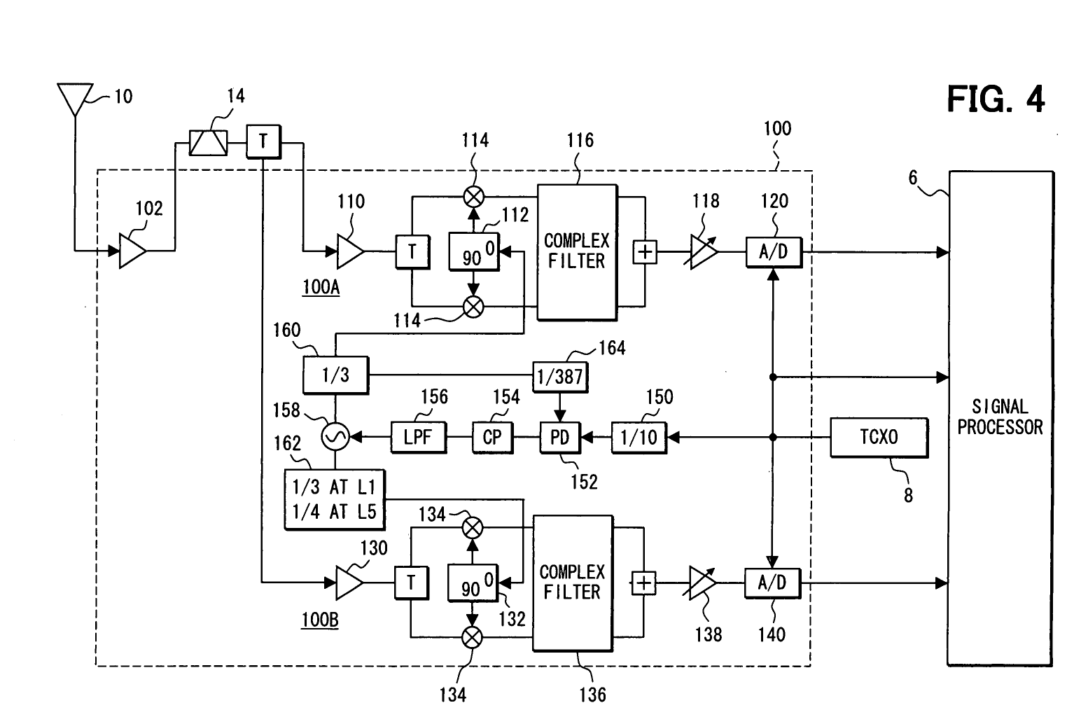

In the fourth embodiment shown in FIG. 4, the same positioning signal of L1 received by one antenna 10 is distributed to two signal reception processing circuits to be processed in parallel.

Since only one antenna 10 is provided, the posture or attitude of the mobile body cannot be detected based on a phase difference. However, the positioning signal of L1 is processed by the signal reception processing circuit, which has the frequency band width for L5 as in the third embodiment. Therefore, it is possible to detect the positioning signal accurately based on the signal processing performed by the circuit having the frequency band width for L5. The positioning error caused by multiple paths can also be reduced.

In the fourth embodiment, the band-pass filter of single frequency band may be replaced with a band-pass filter of dual frequency band to receive and process the positioning signals of L1 and L5.

### Other Embodiments

The number of signal reception processing circuits is not limited to two but may be three or more. In this instance, one positioning signal of the same carrier wave frequency may be received and processed by the first and second signal reception processing circuits, and the other positioning signal of a different carrier wave frequency may be received and processed by a third signal reception processing circuit (not shown).

If the receiver device 100 is thus configured to receive and process positioning signals of three kinds of carrier wave frequencies, a highly accurate positioning result will be provided.

What is claimed is:

1. A receiver device for a satellite positioning system including first and second signal reception processing circuits, which receive and process positioning signals transmitted from satellites, the receiver device comprising:
an oscillation signal generator for generating a reference oscillation signal of a predetermined frequency;
first and second frequency dividers, provided in the first and the second signal reception processing circuits, for producing first and second local oscillation signals by dividing the reference oscillation signal by first and second dividing ratios corresponding to carrier wave frequencies of the positioning signals, respectively; and
first and second mixers, provided in the first and the second signal reception processing circuits, for converting the positioning signals to first and second intermediate frequency signals in a single stage by mixing the positioning signals and the first and the second local oscillation signals, respectively.

2. The receiver device according to claim 1, wherein:
at least one of the first and the second frequency dividers is configured to switch over the dividing ratio in correspondence to the carrier wave frequency of the positioning signal.

3. The receiver device according to claim 1, wherein:
the carrier wave frequencies of the positioning signals received by the first and the second signal reception processing circuits are different from each other; and
the first and the second frequency dividers divide the reference oscillation signal by differentiating the first and the second dividing ratios, respectively.

4. The receiver device according to claim 1, wherein:
the first and the second signal reception processing circuits receive same positioning signal through respective antennas; and
the first and the second frequency dividers produces the first and the second local oscillation signals of same frequency each other.

5. The receiver device according to claim 1, further comprising:
first and second filters provided in the first and the second signal reception processing circuits, respectively,
wherein the first and the second signal reception processing circuits receive same positioning signal, the first and the second frequency dividers produce the first and the second local oscillation signals of same frequency relative to the same positioning signal, and the first and the second frequency filters have different frequency band widths.
